(19) United States
(12) Patent Application Publication
(10) Pub. No.: US 2025/0059416 A1
(43) Pub. Date: Feb. 20, 2025

(54) Reactive Hot Melt Adhesive Composition and the Use Thereof

(71) Applicant: Henkel AG & Co. KGaA, Duesseldorf (DE)

(72) Inventors: Liang Sun, Shanghai (CN); Nan Zhang, Shanghai (CN); Aifu Che, Shanghai (CN)

(21) Appl. No.: 18/724,377

(22) PCT Filed: Jan. 7, 2022
(86) PCT No.: PCT/CN2022/070791

§ 371 Date: Jun. 26, 2024

(51) Int. Cl. C09J 175/06; C09J 9/00

(52) U.S. Cl. CPC C09J 175/06; C09J 9/00

(57) ABSTRACT

The present invention relates to a reactive hot melt adhesive composition and the use thereof. In particular, the present invention provides an adhesive composition having (A) at least one reactive polyurethane prepolymer obtained by reacting a reactant mixture comprising (a) at least one polyol, and (b) at least one polyisocyanate having at least two isocyanate groups in one molecule; (B) at least one vinyl acetate homopolymer having a weight average molecular weight (Mw) of 15,000 to less than 100.000 g/mol and present in an amount of less than 70% by weight based on the total weight of the adhesive composition.

### TECHNICAL FIELD

The present invention relates to reactive hot melt adhesive compositions and the use thereof. In particular, the present invention relates to reactive hot melt adhesive compositions comprising vinyl acetate homopolymer, allowing them to cater to different application needs.

### BACKGROUND

Moisture-curable polyurethane hot melt adhesives are long-established and widespread, which are described for example by H. F. Huber and H. Müller in “Shaping Reactive Hotmelts Using LMW Copolyesters”, Adhesives Age, November 1987, pages 32 to 35. In the context of industrial applications, moisture-curable polyurethane hot melt adhesives can be solid at room temperature, melt to a viscous liquid when heated to a moderate temperature, and applied to substrate to be bonded. The molten adhesive composition then cools and solidifies to form initial bond to the substrate. It can further react with moisture to form crosslinking structure and achieve high final strength. Such adhesives may consist of a polyol component and an isocyanate component with a functionality of two or more. For numerous applications these adhesives are preferred over other adhesives since the adhesive bonds produced using them are of good bond strength, flexibility, and resistance to shock and fatigue.

Nowadays moisture-curable polyurethane hot melt adhesives mixing with resins such as acrylic, ethylene-vinyl acetate (EVA) and thermoplastic polyurethane (TPU) resins is common in the industry to improve the inherent cohesion and initial bonding strength of the adhesive to different materials. Poly(vinyl acetate) (PVAc) has long been used for various applications in different technical fields due to its good bonding strength to various substrates and low odor. For instance, poly(vinyl acetate) is the film-forming ingredient in many water-based (latex) adhesives and paints. However, poly(vinyl acetate) is seldom to be observed in mixing with polyurethane hot melt adhesives due to compatibility issue.

Therefore, there is a need in the art for moisture-curable polyurethane hot melt adhesive that is able to incorporate poly(vinyl acetate) as a component to achieve adhesive compositions having a wide range of open times and good initial bonding strength to different substrates when cured.

### SUMMARY OF THE INVENTION

Disclosed herein is a moisture-curable polyurethane hot melt adhesive composition comprising:
(A) at least one reactive polyurethane prepolymer obtained by reacting a reactant mixture comprising
   (a) at least one polyol, and
   (b) at least one polyisocyanate having at least two isocyanate groups in one molecule; and
(B) at least one vinyl acetate homopolymer having a weight average molecular weight (Mw) of 15,000 to less than 100,000 g/mol and present in an amount of less than 70% by weight, based on the total weight of the adhesive composition.

Also disclosed herein is the cured product of the moisture-curable hot melt adhesive composition according to the present invention.

Also disclosed herein is a laminate, comprising a first substrate, a second substrate, and an adhesive layer sandwiched therebetween, wherein the first and second substrates are independently of each other selected from a glass, a resin, a textile, a wood and a metal, and the adhesive layer being formed by curing the adhesive composition according to the present invention.

Also disclosed herein is the use of the moisture-curable hot melt adhesive composition according to the present invention in manufacturing consumer goods, automotive parts, electronic devices and household appliances.

Other features and aspects of the subject matter are set forth in greater detail below.

### DETAILED DESCRIPTION

It is to be understood by one of ordinary skill in the art that the present discussion is a description of exemplary embodiments only, and is not intended as limiting the broader aspects of the present invention.

Unless specified otherwise, in the context of the present invention, the terms used are to be construed in accordance with the following definitions.

Unless specified otherwise, as used herein, the terms “a”, “an” and “the” include both singular and plural referents.

The terms “comprising” and “comprises” as used herein are synonymous with “including”, “includes” or “containing”, “contains”, and are inclusive or open-ended and do not exclude additional, non-recited members, elements or process steps.

The term “at least one” or “one or more” used herein to define a component refers to the type of the component, and not to the absolute number of molecules. For example, “one or more polyols” means one type of polyol or a mixture of a plurality of different polyols.

The term “amorphous” used herein means having no melt transition when measured using Differential Scanning calorimetry (DSC).

The term “crystalline” used herein means having a melt transition when measured using Differential Scanning calorimetry (DSC).

The term “room temperature” as used herein refers to a temperature of about 20° C. to about 25° C., preferably about 25° C.

Unless specified otherwise, the recitation of numerical end points includes all numbers and fractions subsumed within the respective ranges, as well as the recited end points.

The molecular weights refer to weight average molecular weights (Mw), unless otherwise stipulated. All molecular weight data refer to values obtained by gel permeation chromatography (GPC), unless otherwise stipulated, e.g., according to DIN 55672.

In this context, the glass transition temperature (Tg) or the melting point of a specific polymer is determined using DSC according to DIN 53 765.

Unless otherwise defined, all terms used in the present invention, including technical and scientific terms, have the meaning as commonly understood by one of the ordinary skilled in the art to which this invention belongs.

According to the first aspect, the present invention is generally directed to a moisture-curable polyurethane hot melt adhesive composition comprising:
(A) at least one reactive polyurethane prepolymer obtained by reacting a reactant mixture comprising
   (a) at least one polyol, and
   (b) at least one polyisocyanate having at least two isocyanate groups in one molecule; and
(B) at least one vinyl acetate homopolymer having a weight average molecular weight (Mw) of 15,000 to less than 100,000 g/mol and present in an amount of less than 70% by weight, based on the total weight of the adhesive composition.

### (A) Reactive Polyurethane Prepolymer

According to the present invention, the moisture-curable polyurethane hot melt adhesive composition comprises at least one reactive polyurethane prepolymer obtained by reacting a reactant mixture comprising (a) at least one polyol, and (b) at least one polyisocyanate having at least two isocyanate groups in one molecule.

In some embodiments, the reactive polyurethane prepolymer has a number average molecular weight (Mn) of from 5,000 to 30,000 g/mol, preferably from 8,000 to 20,000 g/mol.

In some embodiments, the component (A) is present in an amount of from greater than 30% to less than 100% by weight, preferably from 40% to 99% by weight, more preferably from 45% to 90% by weight, even more preferably from 50% to 65% by weight, based on the total weight of the adhesive composition.

### (a) Polyol

In some embodiments, the reactant (a) can be selected from polyester polyol, polyether polyol and combinations thereof.

In preferred embodiments, polyester polyol can be used as the reactant (a), which can be selected from solid polyester polyol, liquid polyester polyol, and combinations thereof, preferably selected from crystalline polyester polyol, amorphous polyester polyol, liquid polyester polyol, and combinations thereof.

If present, the crystalline polyester polyols can be used in the present invention which can offer good adhesion strength to the adhesive composition.

Examples of such crystalline polyester polyols can be obtained by ring opening polymerization of a lactone such as ε-caprolactone and/or be derived from diols and diacids. Examples of diols useful in preparing preferred polyester polyols include ethylene glycol, diethylene glycol, 1,3-propylene glycol, 1,4-butanediol, 1,5-pentanediol, 1,6-hexanediol, 1,8-octanediol, 1,10-decanediol, and combinations thereof. Examples of diacids useful in preparing preferred polyester polyols include succinic acid, glutaric acid, adipic acid, suberic acid, azelaic acid, sebacic acid, and 1,12-dodecanedioic acid, dimer acid, and combinations thereof. Included within the scope of useful diacids are various diacid derivatives such as carboxylate esters (especially the methyl and ethyl esters), acid halides (such as acid chlorides) and acid anhydrides, and combinations thereof.

Specific examples of suitable crystalline polyester polyols include poly(hexanediol adipate) polyol, poly(butanediol adipate) polyol, poly-epsilon-caprolactone polyol, poly(hexanediol dodecanedioate) polyol, poly(hexanediol adipic acid terephthalate) polyol, and combinations thereof.

Suitable commercially available crystalline polyester polyols are sold under the DYNACOLL 7300 series of trade designations from Evonik Industries AG including DYNACOLL 7360, 7361, 7362, 7363, 7380, 7381, 7390 etc. and under the CAPA series of trade designations from Perstorp Polyols Inc. including CAPA 2201, 2205, 2209, 2302, 2304, 2402 etc. caprolactone polyols as well as AR U 2720 available from Yong Shun Chemicals Co., Ltd.

If present, amorphous polyester polyols can also be used in preparing the reactive polyurethane prepolymer in the present invention.

The amorphous polyester polyol includes the reaction product of a polyacid component (e.g., polyacid, polyacid anhydride, polyacid ester and polyacid halide), and a stoichiometric excess of polyol. At least one of the polyacid component and the polyol includes an aromatic group. Suitable polyacids include, e.g., diacids (e.g., dicarboxylic acids), triacids (e.g., tricarboxylic acids), and higher order acids, examples of which include aromatic dicarboxylic acids, anhydrides and esters thereof (e.g. terephthalic acid, isophthalic acid, dimethyl terephthalate, diethyl terephthalate, phthalic acid, phthalic anhydride, methyl-hexahydrophthalic acid, methyl-hexahydrophthalic anhydride, methyl-tetrahydrophthalic acid, methyl-tetrahydrophthalic anhydride, hexahydrophthalic acid, hexahydrophthalic anhydride, and tetrahydrophthalic acid), aliphatic dicarboxylic acids and anhydrides thereof (e.g. maleic acid, maleic anhydride, succinic acid, succinic anhydride, glutaric acid, glutaric anhydride, adipic acid, pimelic acid, suberic acid, azelaic acid, sebacic acid, chlorendic acid, 1,2,4-butane-tricarboxylic acid, decanedicarboxylic acid, octadecanedicarboxylic acid, dimeric acid, dimerized fatty acids, trimeric fatty acids, and fumaric acid), and alicyclic dicarboxylic acids (e.g. 1,3-cyclohexanedicarboxylic acid, and 1,4-cyclohexanedicarboxylic acid), and mixture thereof. Examples of suitable polyols include aliphatic polyols, e.g., ethylene glycols, propane diols (e.g., 1,2-propanediol and 1,3-propanediol), butanediols (e.g., 1,3-butanediol, 1,4-butanediol, and 1,2-butanediol), 1,3-butenediol, 1,4-butenediol, 1,4-butynediol, pentane diols (e.g., 1,5-pentanediol), pentenediols, pentynediols, 1,6-hexanediol, 1,8-octanediol, 1,10-decanediol, neopentyl glycol, diethylene glycol, triethylene glycol, tetraethylene glycol, polyethylene glycols, propylene glycol, polypropylene glycols (e.g., dipropylene glycol and tripropylene glycol), 1,4-cyclohexanedimethanol, 1,4-cyclohexanediol, dimer diols, bisphenol A, bisphenol F, hydrogenated bisphenol A, hydrogenated bisphenol F, glycerol, tetramethylene glycol, polytetramethylene glycol, 3-methyl-1,5-pentanediol, 1,9-nonanediol, 2-methyl-1,8-octanediol, trimethylolpropane, pentaerythritol, sorbitol, glucose, and combinations thereof.

Specific examples of useful amorphous polyester polyols, if present, include poly(hexanediol phthalate) polyol, poly(neopentyl glycol adipate) polyol, poly(neopentyl glycol phthalate) polyol, poly(neopentyl glycol hexanediol phthalate) polyol, poly(diethylene glycol phthalate) polyol, poly(ethylene glycol adipic acid terephthalate) polyol, polyethylene terephthalate polyols, random copolymer diols of ethylene glycol, hexane diol, neopentyl glycol, adipic acid and terephthalic acid, and combinations thereof.

Useful amorphous polyester polyols are commercially available under a variety of trade designations including, e.g., DYNACOLL 7110, 7130, 7140 and 7150 from Evonik Industries AG, and FLP PA-1000N from Xuchuan Chemical (Suzhou) Co., Ltd.

In some embodiments, the polyester polyols used in this invention can be liquid at room temperature, which provides wetting properties to the adhesive composition and impact resistance to the cured product. Accordingly, the liquid polyester polyol preferably has a glass transition temperature (Tg) of no larger than 0° C. If the Tg of the liquid polyester polyol is too high, it is more difficult to be in liquid status.

Examples of suitable liquid polyester polyols can be obtained by ring opening polymerization of a lactone such as ε-caprolactone and/or be derived from diols and diacids. Examples of diols useful in preparing preferred polyester polyols include ethylene glycol, diethylene glycol, 1,3-propylene glycol, 1,4-butanediol, 1,5-pentanediol, 1,6-hexanediol, 1,8-octanediol, 1,10-decanediol, and combinations thereof. Examples of diacids useful in preparing preferred polyester polyols include succinic acid, glutaric acid, adipic acid, suberic acid, azelaic acid, sebacic acid, and 1,12-dodecanedioic acid, dimer acid, and combinations thereof. Included within the scope of useful diacids are various diacid derivatives such as carboxylate esters (especially the methyl and ethyl esters), acid halides (such as acid chlorides) and acid anhydrides, and combinations thereof.

Specific examples of suitable liquid polyester polyols include poly(hexanediol adipate) polyol, poly(butanediol adipate) polyol, poly-epsilon-caprolactone polyol, poly(hexanediol dodecanedioate) polyol, poly(hexanediol adipic acid terephthalate) polyol, and mixtures thereof.

Suitable commercially available liquid polyester polyols are sold under the DYNACOLL 7200 series of trade designations from Evonik Industries AG including DYNACOLL 7210, 7230, 7231, 7250, etc and Stepan PDP 70 from Stepan Corporation.

In some embodiments, the reactant (a) can be polyether polyol.

The polyether polyols used in the present invention are well known to those skilled in the art. These polyether polyols are obtained by copolymerizing at least one compound of ethylene oxide, propylene oxide, butylene oxide, tetrahydrofuran, etc. with at least one compound having at least two active hydrogen atoms on average in one molecule such as the polyhydric alcohols list above which include ethylene glycol, propylene glycol, dipropylene glycol, glycerol, and combinations thereof. Other suitable polyhydric compounds include sucrose, ethylenediamine, propylenediamine, triethanolamine, 1,2-propanedithiol, and combinations thereof.

Preferred polyether polyols can be selected from polytetramethylene ether glycol, poly(oxypropylene) glycol, polyethylene oxide, polybuthylene oxide, and ethylene oxide endcapped versions of any of the foregoing, as well as the combinations thereof. The most preferred polyether polyols are polytetramethylene ether glycol, poly(oxypropylene) glycol, ethylene oxide endcapped poly(oxypropylene) glycol, and combinations thereof.

In preferred embodiments, the polyether polyol has a number average molecular weight (Mn) of from 200 to 8,000 g/mol, preferably from 400 to 4,000 g/mol, and more preferably from 400 to 2,000 g/mol.

It is possible to use commercially available products in the present invention. Examples thereof include Voranol 2104, 2110, 2120 and 2140 from Dow Chemical Company.

In some embodiments, the reactant (a) is a combination of polyester polyol and polyether polyol. Preferably, polyether polyol is not comprised in the reactant (a) to form reactive polyurethane prepolymer of the present invention.

With particular preference, the reactant (a) may be present in an amount of from 20% to 85% by weight, and more preferably from 40% to 80% by weight, based on the total weight of the adhesive composition.

### (b) Polyisocyanate

According to the present invention, the moisture-curable polyurethane hot melt adhesive composition comprises at least one reactive polyurethane prepolymer obtained by reacting a reactant mixture comprising (a) at least one polyol, and (b) at least one polyisocyanate having at least two isocyanate groups in one molecule.

Useful polyisocyanates as reactant (b) include any suitable isocyanate having at least two isocyanate groups in one molecule including, e.g., aliphatic, cyclopaliphatic, araliphatic, arylalkyl, and aromatic isocyanates, and combinations thereof.

Preferable reactant (b) can be selected from 4,4′-diphenylmethane diisocyanate (MDI), hydrogenated MDI (H12MDI), partly hydrogenated MDI (H6MDI), xylylene diisocyanate (XDI), tetramethylxylylene diisocyanate (TMXDI), 4,4′-diphenyldimethylmethane diisocyanate, dialkylenediphenylmethane diisocyanate, tetraalkylenediphenylmethane diisocyanate, 4,4′-dibenzyl diisocyanate, 1,3-phenylene diisocyanate, 1,4-phenylene diisocyanate, the isomers of toluylene diisocyanate (TDI), 1-methyl-2,4-diisocyanatocyclohexane, 1,6-diisocyanato-2,2,4-trimethylhexane, 1,6-diisocyanato-2,4,4-trimethylhexane, 1-isocyanatomethyl-3-isocyanato-1,5,5-trimethylcyclohexane (IPDI), tetramethoxybutane-1,4-diisocyanate, naphthalene-1,5-diisocyanate (NDI), butane-1,4-diisocyanate, hexane-1,6-diisocyanate (HDI), dicyclohexylmethane diisocyanate, 2,2,4-trimethylhexane-2,3,3-trimethylhexamethylene diisocyanate, cyclohexane-1,4-diisocyanate, ethylene diisocyanate, methylenetriphenyltriisocyanate (MIT), phthalic acid bisisocyanatoethyl ester, trimethylhexamethylene diisocyanate, 1,4-diisocyanatobutane, 1,12-diisocyanatododecane, dimer fatty acid diisocyanate, lysine ester diisocyanate, 4,4′-dicyclohexylmethane diisocyanate, 1,3-cyclohexane or 1,4-cyclohexane diisocyanate, and combinations thereof. The most preferred polyisocyanate is 4,4′-diphenylmethane diisocyanate (MDI) and its isomers, chain-extended MDI, and combinations thereof.

Useful commercially available polyisocyanates used as reactant (b) include DESMODUR 44 C FUSED, Desmodur 0118 I and Desmodur 44M from Covestro, Vannate MDI 100F from Wanhua Chemicals, Supresec 1809 from HUNTSMAN.

With particular preference, the reactant (b) may be present in an amount of from 5% to 25% by weight, and preferably from 10% to 20% by weight, based on the total weight of the adhesive composition.

### (B) Vinyl Acetate Homopolymer

According to the present invention, the moisture-curable polyurethane hot melt adhesive composition comprises (B) at least one vinyl acetate homopolymer having a weight average molecular weight (Mw) of from 15,000 to less than 100,000 g/mol and present in an amount of less than 70% by weight, based on the total weight of the adhesive composition.

In preferred embodiments, the component (B) used in the present invention may be vinyl acetate homopolymer having in the range of from 30,000 to 60,000 g/mol, more preferably in the range from 45,000 to 55,000 g/mol.

Suitable vinyl acetate homopolymers used as the component (B) of the present invention can generally prepared by emulsion polymerization techniques wherein typically small quantities of wetting agents, protective colloids, polymerization initiator and a molecular weight regulator, may be included in addition to vinyl acetate monomer and water.

Useful commercially available vinyl acetate homopolymer used as component (B) includes Vinnapas™ N 1.5 SP, Vinnapas™ N 17 SP, Vinnapas™ N 30 SP from Wacker Chemicals (China) Co., Ltd.

With particular preference, the component (B) may be present in an amount of greater than 0 to less than 70% by weight, preferably from 1% to 60% by weight, more preferably from 5% to 45%, based on the total weight of the adhesive composition.

### (C) Catalyst

Optionally, the moisture-curable polyurethane hot melt adhesive composition may also comprise a catalyst (C) to facilitate the reaction between the (a) polyols and (b) polyisocyanate having at least two isocyanate groups in one molecule.

Suitable components (C) include, for example, strongly basic amides, such as 2,3-dimethyl-3,4,5,6-tetrahydropyrimidine, tris-(dialkylaminoalkyl)-s-hexahydrotriazines, for example tris-(N,N-dimethylaminopropyl)-s-hexahydrotriazine or the usual tertiary amines, for example triethylamine, tributylamine, dimethylbenzylamine, N-ethyl-, N-methyl-, N-cyclo-hexylmorpholine, dimethylcyclohexylamine, dimorpholinodiethylether, 2-(dimethylaminoethoxy)-ethanol, 1,4diazabicyclo[2,2,2]octane, 1-azabicyclo[3,3,0]octane, N,N,N′,N′-tetramethyl ethylenediamine, N,N,N′,N′-tetramethyl butanediamine, N,N,N′,N′-tetramethyl hexane-1,6-diamine, pentamethyl diethylenetriamine, tetramethyl diaminoethylether, bis-(dimethylaminopropyl)-urea, N,N′-dimethylpiperazine, 1,2-dimethylimidazole, di-(4-N,N-dimethylaminocyclohexyl)-methane and the like and organometallic compounds, such as titanic acid esters, iron compounds, for example iron (III) acetyl acetonate, tin compounds, for example tin (II) salts of organic carboxylic acids, for example tin (II) diacetate, the tin (II) salt of 2-ethylhexanoic acid (tin (II) octoate), tin (II) dilaurate or the dialkyltin (IV) salts of organic carboxylic acids, for example dibutyltin (IV) diacetate, dibutyltin (IV) dilaurate, dibutyltin (IV) maleate or dioctyltin (IV) diacetate or the like, and dibutyltin (IV) dimercaptide or mixtures of two or more of the catalysts mentioned and synergistic combinations of strongly basic amines and organometallic compounds.

With particular preference, the catalyst may be present in the adhesive composition in an amount of from 0 to 1% by weight, and preferably from 0.01% to 0.5% by weight, based on the total weight of the adhesive composition.

### (D) Additives

Optionally, the moisture-curable polyurethane hot melt adhesive composition may comprise at least one additive. Such additive can be those commonly used in the art, such as colorants, antioxidants, leveling agent, anti-yellowing additives, etc.

Examples of colorants include pigments which may be selected from metal oxide pigments, titanium dioxide, optionally surface-treated, zirconium oxide or cerium oxide, zinc oxide, iron oxide (black, yellow or red), chromium oxide, manganese, and combinations thereof.

Examples of antioxidants include phenolic types such as BHT (butylated hydroxytoluene), octadecyl-3,5-bis(1,1-dimethyl)-4-hydroxybenzene-propanoate, and pyrogallol; phosphites such as triphenyl phosphite, tris(nonylphenyl)phosphite; or thioesters such as dilauryl thiodipropionate, and combinations thereof.

With particular preference, the additive(s) may be present in an amount of from 0 to 5% by weight, and preferably from 0.05% to 2% by weight, based on the total weight of the adhesive composition.

### Adhesive Composition

In particular preferred embodiments, the moisture-curable polyurethane hot melt adhesive composition, based on the total weight of the adhesive composition, comprises:
from greater than 30% to less than 100% by weight, preferably from 40% to 99% by weight, more preferably from 45% to 90% by weight, even more preferably from 50% to 65% by weight of (A) at least one reactive polyurethane prepolymer obtained by reacting a reactant mixture comprising
   (a) at least one polyol, and
   (b) at least one polyisocyanate having at least two isocyanate groups in one molecule;
from greater than 0 to less than 70% by weight, preferably from 1% to 60% by weight, more preferably from 5% to 45% by weight of (B) at least one vinyl acetate homopolymer having a weight average molecular weight (Mw) of 15,000 to less than 100,000 g/mol,
from 0% to 1% by weight, preferably from 0.01% to 0.5% by weight of (C) catalyst, and
from 0% to 5% by weight, preferably from 0.05% to 2% by weight of (D) additive.

### Preparation Method

The moisture-curable polyurethane hot melt adhesive composition according to the present invention can be prepared by steps as follows to obtain the composition:
(i) mixing the reactant (a) and the component (B) at a temperature from 125° C. to 150° C. and then vacuuming;
(ii) decreasing the temperature to 100° C. to 120° C. and adding the reactant (b) and controlling the reaction temperature from 120 to 130° C.; and
(iii) mixing 1 to 2 hours to homogeneity under vacuum and then discharging.

The apparatuses for these mixing, stirring, dispersing, and the like are not particularly limited. There can be used an automated mortar, a Henschel mixer, a three-roll mill, a ball mill, a planetary mixer, a bead mill, and the like which are equipped with a stirrer and a heater. Also, an appropriate combination of these apparatuses may be used. The preparation method of the moisture-curable polyurethane hot melt adhesive composition is not particularly limited, as long as a composition in which the above-described components are uniformly mixed.

### Cured Product and Laminate

The moisture-curable polyurethane hot melt adhesive composition of the present invention can cure from 15° C. to 35° C., preferably at room temperature, and 50% relative humidity for from 1 to 7 days.

As will be understood, the time and temperature curing profile for each moisture-curable polyurethane hot melt adhesive composition will vary, and different compositions can be designed to provide the curing profile that will be suited to the particularly industrial manufacturing process.

According to a second aspect of the invention, provided herein is a cured product of the moisture-curable polyurethane hot melt adhesive of the present invention.

According to a third aspect of the invention, provided herein is a laminate, comprising a first substrate, a second substrate, and an adhesive layer sandwiched therebetween, wherein the first and second substrates are independently of each other selected from a glass, a resin, a textile, a wood and a metal, and the adhesive layer being formed by curing the adhesive composition of the present invention.

Specifically, the moisture-curable polyurethane reactive hot melt adhesive composition according to the present invention having the component (B) present in an amount of less than 30% by weight, preferably less than 20% by weight based on the total weight of the adhesive composition may be used in bonding textile to textile, or bonding textile to foam in garments. While the moisture-curable polyurethane reactive hot melt adhesive composition according to the present invention having the component (B) present in an amount of from 30% to less than 70% by weight, preferably from 45% to less than 70% by weight based on the total weight of the adhesive composition may be used in bonding wood substrates.

The first substrate and/or second substrate can be of a single material and a single layer or can include multiple layers of the same or different material. The layers can be continuous or discontinuous.

The substrates of the article descried herein can have a variety of properties including rigidity (e.g., rigid substrates i.e., the substrate cannot be bent by an individual using two hands or will break if an attempt is made to bend the substrate with two hands), flexibility (e.g., flexible substrates i.e., the substrate can be bent using no greater than the force of two hands), porosity, conductivity, lack of conductivity, and combinations thereof.

The substrates of the article can be in a variety of forms including, e.g., fibers, threads, yarns, wovens, nonwovens, films (e.g., polymer film, metallized polymer film, continuous films, discontinuous films, and combinations thereof), foils (e.g., metal foil), sheets (e.g., metal sheet, polymer sheet, continuous sheets, discontinuous sheets, and combinations thereof), and combinations thereof.

In preferred embodiments, at least one of the substrates can be selected from metals, such as metal firing pastes, aluminum, tin, molybdenum, silver, conductive metal oxides such as indium tin oxide (ITO), fluorine doped tin oxide, aluminum doped zinc oxide etc, glasses such as inked glass, bare glass, resins such as polycarbonate, polybutylece terephthalate, polyethylene terephthalate and polyamide, polyvinyl chloride. Further suitable metals include copper, gold, palladium, platinum, aluminum, indium, silver coated copper, silver coated aluminum, tin, and tin coated copper. Preferably both substrates are selected from one of the aforementioned materials.

The moisture-curable polyurethane hot melt adhesive composition of the present invention can be applied to a substrate using any suitable application method including, e.g., automatic fine line dispensing, jet dispensing, slot die coating, roll coating, gravure coating, transfer coating, pattern coating, screen printing, spray coating, filament coating, by extrusion, air knife, trailing blade, brushing, dipping, doctor blade, offset gravure coating, rotogravure coating, and combinations thereof. The moisture-curable polyurethane hot melt adhesive composition can be applied as a continuous or discontinuous coating, in a single or multiple layers and combinations thereof.

### Use

According to the present invention, the moisture-curable polyurethane reactive hot melt adhesive compositions are useful in manufacturing consumer goods, automotive parts, electronic devices and household appliances.

The said suitable consumer goods include, but not limited to, e.g., textile and garment, carpentry works and furniture, paper and plastic packages as well as other components.

The said suitable electronic devices include, but not limited to, e.g., wearable electronic devices (e.g., wrist watches and eyeglasses), handheld electronic devices (e.g., phones (e.g., cellular telephones and cellular smartphones), cameras, tablets, electronic readers, monitors (e.g., monitors used in hospitals, and by healthcare workers, athletes and individuals), watches, calculators, mice, touch pads, and joy sticks), computers (e.g., desk top and lap top computers), computer monitors, televisions, media players, or other electronic components.

The said suitable household appliances include, but not limited to, e.g., refrigerators, washing machines, dryers, ovens, and microwaves), light bulbs (e.g., incandescent, light emitting diode, and fluorescent), and other articles.

### EXAMPLES

The following examples are intended to assist one skilled in the art to better understand and practice the present invention. The scope of the invention is not limited by the examples but is defined in the appended claims. All parts and percentages are based on weight unless otherwise stated.

### Raw Materials

AR U 2720 is polyester polyol available from Yong Shun Chemicals Co., Ltd.

Desmodur™ 44 M is 4,4′-MDI available from Covestro.

Vinnapas™ N 17 SP is vinyl acetate homopolymer having a weight average molecular weight (Mw) of 45,000 g/mol available from Wacker Chemicals (China) Co. Ltd.

Vinnapas™ N 1.5 SP is vinyl acetate homopolymer having a weight average molecular weight (Mw) of 15,000 g/mol available from Wacker Chemicals (China) Co. Ltd.

Vinnapas™ N 30 SP is vinyl acetate homopolymer having a weight average molecular weight (Mw) of 55,000 g/mol available from Wacker Chemicals (China) Co. Ltd.

Vinnapa™ N 100 SP is vinyl acetate homopolymer having a weight average molecular weight (Mw) of 100,000 g/mol available from Wacker Chemicals (China) Co. Ltd.

Hanwha 1540 is ethylene-vinyl acetate copolymer available from Hanwha Chemicals.

Elvacite™ M 2013 is acrylic resin available from Mitsubishi Chemical Corporation.

Pearlbond™ 521 is polycaprolactone-copolyester polyurethane available from Lubrizol.

### Sample Preparation

The samples were prepared according to the formulations listed in Tables 1, 2 and 3. The total weight of all components is 100 weight parts. In the following tables, the compositions were prepared by the following steps: (i) mixing the reactant (a) and the component (B) or other resins replacing the component (B) at a temperature from 125° C. to 150° C. and then vacuuming;
(ii) decreasing the temperature to 100° C. to 120° C. and adding the reactant (b) and controlling the reaction temperature from 120 to 130° C.; and
(iii) mixing 1 to 2 hours under vacuum and then discharging.

The obtained composition's status was recorded as “homogeneous” or “phase separation” by visual observation. The compositions having “phase separation” means that components in the respective composition had compatible problem, as such, leading to low workability and therefore cannot be acceptable.

### Testing Method:

### Viscosity for Hot Melt Adhesive Composition

The viscosity in the present invention was measured at a temperature range at 130° C. with a 27# spindle, and a Brookfield viscometer. The viscosity less than 10000 cps is acceptable.

### Initial Bonding Strength at 2 Minutes and 10 Minutes

Each sample prepared as above was coated between two layers of PET films (available from Lianrui Corporation in Dongguan) in a size of 1 m*0.18 m by a roller heater (available from Weite Corporation in Taiwan) at 105° C. with a thickness of 50 μm so as to give a laminated sample.

The laminated sample was cured at 23° C. and 50% relative humidity for 2 minutes. 180° peeling strength was recorded as the initial bonding strength of the cured laminated sample. The laminated sample was placed in a tensile machine (available from Shenzhen SANS Testing Machine Co., Ltd) and the initial bonding strength was measured at 300 mm/min peeling speed. Each initial bonding strength at 2 minutes was measured for 3 times and the average value was recorded. The initial bonding strength at 10 minutes no less than 0.2 N/inch with 100% Cohesive Failure mode can be acceptable. As referred herein, “Cohesive Failure mode” refers to that the adhesive splits and portions of the adhesive remain adhered to each of the bonded surfaces. A failure mode wherein an adhesive is removed cleanly from the substrate is referred to as “Adhesive Failure mode”. An adhesive having Cohesive Failure mode is considered to be more robust than those having Adhesive Failure mode.

The laminated sample was cured at 23° C. and 50% relative humidity for 10 minutes. The initial bonding strength of the cured laminated sample was measured according to JIS L1093 Method A-1. Each initial bonding strength at 10 minutes was measured for 3 times and the average value was recorded. The initial bonding strength at 10 minutes no less than 0.2 N/inch with 100% Cohesive Failure mode can be acceptable.

### Open Time

10 g of the adhesive composition prepared as above was coated on paper by an automatic film applicator (4340, available from Elecometer Corporation) at 130° C. with a thickness of 100 μm. A paper stripe in a size of 2.5 cm*10 cm was attached to the coated paper by finger pressure every 10 to 30 seconds. The open time was defined as the time until fiber tear of the paper stripe was observed. The adhesive composition having open time from 1 to larger than 20 minutes were acceptable.

### Inventive Example 1 and Comparative Examples 1 to 3

In this set of examples, one moisture-curable polyurethane reactive hot melt adhesive composition of the present invention (Ex. 1) and three compositions replacing component (B) of the present invention with other resins (Com. Ex. 1 to Com. Ex. 3) were prepared based on weight percentage specified in the Table 1.

TABLE 1

| Components (weight parts) | Ex. 1 | Com Ex 1 | Com Ex 2 | Com Ex 3 |
|---|---|---|---|---|
| AR U 2720 | 65.35 | 65.35 | 65.35 | 65.35 |
| Desmodur ™ 44 M | 14.65 | 14.65 | 14.65 | 14.65 |
| Vinnapas ™ N 17 SP | 20 | 0 | 0 | 0 |
| Hanwha 1540 | 0 | 20 | 0 | 0 |
| Elvacite ™ 2013 | 0 | 0 | 20 | 0 |
| Pearlbond ™ 521 | 0 | 0 | 0 | 20 |

Testing result

| | | | | |
|---|---|---|---|---|
| Mixture status by | homo- | phase | phase | phase |
| observation | geneous | separation | separation | separation |
| Viscosity (cps) | 2885 | N/A | N/A | N/A |
| Initial bonding strength | CF | N/A | N/A | N/A |
| at 2 mins/failure mode | | | | |
| Initial bonding strength | 0.46 | N/A | N/A | N/A |
| at 2 mins (N/inch) | | | | |
| Initial bonding strength | CF | N/A | N/A | N/A |
| at 10 mins/failure mode | | | | |
| Initial bonding strength | 0.6 | N/A | N/A | N/A |
| at 10 min (N/inch) | | | | |
| Open time (min) | >20 | N/A | N/A | N/A |

Remarks: N/A refers to the respective testing cannot be conducted due to homogenous composition cannot be achieved.

As can be seen from Table 1, compositions of Com. Ex. 1 to Com. Ex. 3 having resins other than component (B) had compatibility issue, while composition of the present invention (Ex. 1) showed outstanding performance.

### Inventive Example 2 to 4 and Comparative Examples 4 to 5

In this set of examples, the moisture-curable polyurethane reactive hot melt adhesive compositions of the present invention (Ex. 2 to 4) and two compositions having component (B) out of the claimed weight percentage of the present invention (Com. Ex. 4 to 5) were prepared based on weight percentage specified in the Table 2.

TABLE 2

| Components (weight parts) | Ex. 2 | Ex. 3 | Ex. 4 | Com Ex 4 | Com Ex 5 |
|---|---|---|---|---|---|
| AR U 2720 | 77.6 | 65.35 | 44.93 | 81.69 | 24.5 |
| Desmodur ™ 44 M | 17.4 | 14.65 | 10.07 | 18.31 | 5.5 |
| Vinnapas ™ N 17 SP | 5 | 20 | 45 | 0 | 70 |

Testing result

| | | | | | |
|---|---|---|---|---|---|
| Mixture status by | homo- | homo- | homo- | homo- | homo- |
| observation | geneous | geneous | geneous | geneous | geneous |
| Viscosity (cps) | 1970 | 2885 | 9433 | 1645 | 13400 |
| Initial bonding strength | CF | CF | CF | CF | AF |
| at 2 mins/failure mode | | | | | |
| Initial bonding strength | 0.28 | 0.46 | 11.3 | 0.15 | 0.4 |
| at 2 mins (N/inch) | | | | | |
| Initial bonding strength | CF | CF | CF | CF | AF |
| at 10 mins/failure mode | | | | | |
| Initial bonding strength | 0.3 | 0.6 | 12.4 | 0.15 | 0.4 |
| at 10 min (N/inch) | | | | | |
| Open time (min) | >20 | >20 | 1 | >20 | almost no |
| | | | | | open time |

As can be seen from Table 2, compositions having Component (B) out of the claimed weight percentage of the present invention (Com. Ex. 4 to Com. Ex. 5) either had barely zero open time or had unacceptable initial bonding strength at 2 mins and 10 mins, while compositions of the present invention (Ex. 2 to Ex. 4) showed outstanding performance.

### Inventive Example 5 to 7 and Comparative Examples 6

In this set of examples, the moisture-curable polyurethane reactive hot melt adhesive compositions having component (B) with different weight average molecular weight (Mw) were prepared based on weight percentage specified in the Table 3.

TABLE 3

| Components (weight parts) | Ex. 5 | Ex. 6 | Ex. 7 | Com Ex 6 |
|---|---|---|---|---|
| AR U 2720 | 65.35 | 65.35 | 65.35 | 65.35 |
| Desmodur ™ 44 M | 14.65 | 14.65 | 14.65 | 14.65 |
| Vinnapas ™ N 1.5 SP | 20 | 0 | 0 | 0 |
| Vinnapas ™ N 17 SP | 0 | 20 | 0 | 0 |
| Vinnapas ™ N 30 SP | 0 | 0 | 20 | 0 |
| Vinnapas ™ N 100 SP | 0 | 0 | 0 | 20 |

Testing result

| | | | | |
|---|---|---|---|---|
| Mixture status by | homo- | homo- | homo- | phase |
| observation | geneous | geneous | geneous | separation |
| Viscosity (cps) | 1485 | 2885 | 3190 | N/A |
| Initial bonding strength | CF | CF | CF | N/A |
| at 2 mins/failure mode | | | | |
| Initial bonding strength | 0.5 | 0.46 | 0.61 | N/A |
| at 2 mins (N/inch) | | | | |
| Initial bonding strength | CF | CF | CF | N/A |
| at 10 mins/failure mode | | | | |
| Initial bonding strength | 0.53 | 0.6 | 0.71 | N/A |
| at 10 min (N/inch) | | | | |
| Open time (min) | >20 | >20 | >20 | N/A |

Remarks: N/A refers to the respective testing cannot be conducted due to homogenous composition cannot be achieved.

As shown by the testing results in Table 3, the adhesive composition comprising Component (B) having a weight average molecular weight (Mw) of 100,000 g/mol (Com. Ex. 6) caused phase separation.

These and other modifications and variations of the present invention may be practiced by those of ordinary skill in the art, without departing from the spirit and scope of the present invention. In addition, it should be understood that aspects of the various embodiments may be interchanged in whole or in reactant. Furthermore, those of ordinary skill in the art will appreciate that the foregoing description is by way of example only, and is not intended to limit the invention so further described in such appended claims.

1. A moisture-curable polyurethane hot melt adhesive composition comprising:
(A) at least one reactive polyurethane prepolymer obtained by reacting a reactant mixture comprising
(a) at least one polyol, and
(b) at least one polyisocyanate having at least two isocyanate groups in one molecule;
(B) at least one vinyl acetate homopolymer having a weight average molecular weight (Mw) of 15,000 to less than 100,000 g/mol and present in an amount of less than 70% by weight based on the total weight of the adhesive composition.

2. The moisture-curable polyurethane hot melt adhesive composition according to claim 1, wherein the reactant (a) is selected from polyester polyol, polyether polyol and combinations thereof.

3. The moisture-curable polyurethane hot melt adhesive composition according to claim 2, wherein the polyester polyol used as the reactant (a) is selected from solid polyester polyol, liquid polyester polyol, and combinations thereof.

4. The moisture-curable polyurethane hot melt adhesive composition according to claim 3, wherein the polyester polyol used as the reactant (a) has a number molecular weight (Mn) of 800 to 20,000 g/mol.

5. The moisture-curable polyurethane hot melt adhesive composition according to claim 2, wherein the polyether polyol used as the reactant (a) is selected from polytetramethylene ether glycol, poly(oxypropylene) glycol, polyethylene oxide, polybutylene oxide, and ethylene oxide endcapped versions of any of the foregoing, as well as the combinations thereof.

6. The moisture-curable polyurethane hot melt adhesive composition according to claim 1, wherein the reactant (b) is selected from 4,4′-diphenylmethane diisocyanate (MDI), hydrogenated MDI (H12MDI), partly hydrogenated MDI (H6MDI), xylylene diisocyanate (XDI), tetramethylxylylene diisocyanate (TMXDI), 4,4-diphenyldimethylmethane diisocyanate, dialkylenediphenylmethane diisocyanate, tetraalkylenediphenylmethane diisocyanate, 4,4′-dibenzyl diisocyanate, 1,3-phenylene diisocyanate, 1,4-phenylene diisocyanate, the isomers of toluylene diisocyanate (TDI), 1-methyl-2,4-diisocyanatocyclohexane, 1,6-diisocyanato-2,2,4-trimethylhexane, 1,6-diisocyanato-2,4,4-trimethylhexane, 1-isocyanatomethyl-3-isocyanato-1,5,5-trimethylcyclohexane (IPDI), tetramethoxybutane-1,4-diisocyanate, naphthalene-1,5-diisocyanate (NDI), butane-1,4-diisocyanate, hexane-1,6-diisocyanate (HDI), dicyclohexylmethane diisocyanate, 2,2,4-trimethylhexane-2,3,3-trimethylhexamethylene diisocyanate, cyclohexane-1,4-diisocyanate, ethylene diisocyanate, methylenetriphenyltriisocyanate (MIT), phthalic acid bisisocyanatoethyl ester, trimethylhexamethylene diisocyanate, 1,4-diisocyanatobutane, 1,12-diisocyanatododecane, dimer fatty acid diisocyanate, lysine ester diisocyanate, 4,4-dicyclohexylmethane diisocyanate, 1,3-cyclohexane or 1,4-cyclohexane diisocyanate, and combinations thereof.

7. The moisture-curable polyurethane hot melt adhesive composition according to claim 1, wherein the component (B) has a weight average molecular weight (Mw) 30,000 to 60,000 g/mol.

8. The moisture-curable polyurethane hot melt adhesive composition according to claim any of the claim 1, wherein the adhesive composition further comprises at least one catalyst (C) selected from strongly basic amides, triethylamine, tributylamine, dimethylbenzylamine, N-ethyl-, N-methyl-, N-cyclo-hexylmorpholine, dimethylcyclohexylamine, dimorpholinodiethylether, 2-(dimethylaminoethoxy)-ethanol, 1,4-diazabicyclo[2,2,2]octane, 1-azabicyclo[3,3,0]octane, N,N,N′,N′-tetramethyl ethylenediamine, N,N,N′,N′-tetramethyl butanediamine, N,N,N′,N′-tetramethyl hexane-1,6-diamine, pentamethyl diethylenetriamine, tetramethyl diaminoethylether, bis-(dimethylaminopropyl)-urea, N,N′-dimethylpiperazine, 1,2-dimethylimidazole, di-(4-N,N-dimethylaminocyclohexyl)-methane, organometallic compounds, and combinations thereof.

9. The moisture-curable polyurethane hot melt adhesive composition according to claim any of the claim 1, wherein the adhesive composition further comprises (D) at least one additive.

10. The moisture-curable polyurethane hot melt adhesive composition according to claim any of the claim 1, wherein the reactant (a) is present in an amount of from 20% to 85% by weight.

11. The moisture-curable polyurethane hot melt adhesive composition according to claim any of the claim 1, wherein the reactant (b) is present in an amount of from 5% to 25% by weight, based on the total weight of the adhesive composition.

12. The moisture-curable polyurethane hot melt adhesive composition according to claim 1, wherein the component (B) is present in an amount of from 1% to 60% by weight based on the total weight of the adhesive composition.

13. Cured product of the reactive hot melt adhesive composition according to claim 1.

14. A laminate, comprising a first substrate, a second substrate, and an adhesive layer sandwiched therebetween, wherein the first and second substrates are independently of each other selected from a glass, a resin, a textile, a wood and a metal, and the adhesive layer being formed by curing the adhesive composition according to claim 1.

15. (canceled)
